(19) United States
(12) Patent Application Publication
(10) Pub. No.: US 2007/0235554 A1
(43) Pub. Date: Oct. 11, 2007

(54) Dual stroke injector using SMA

(76) Inventors: Arthur R. Williams, Spencerport, NY (US); Allan R. Wells, Rochester, NY (US)

Correspondence Address: Jimmy L. Funke, Esq.;Delphi Technologies, Inc., Mail Code 480410202, P.O. Box 5052, Troy, MI, 48007, US

(21) Appl. No.: 11/392,152

(22) Filed: Mar. 29, 2006

(51) Int. Cl. B05B 1/08

(52) U.S. Cl. 239/102.2; 239/533.2

(57) ABSTRACT

A dual stroke fuel injector including a shape memory alloy component for controlling the short and long strokes of the injector.

### TECHNICAL FIELD

The present invention relates to fuel injectors and, more particularly, to a dual stroke fuel injector including a shape memory alloy (SMA).

### BACKGROUND OF THE INVENTION

Both single stroke and dual stroke fuel injectors are known. In a common fuel injector design, a needle valve controls fuel flow through the injector and into the combustion chamber. In a single stroke injector, the needle is only movable from the closed position to a single open position. In a dual stroke injector, the needle may be moved between two different opening positions each providing a different flow area through which fuel may flow out of the injector and into the combustion chamber or intake manifold. As such, a dual stroke injector allows for a variable injector stroke position that correlates to a respectively variable engine load condition. The movement of the valve needle in both the single stroke and dual stroke injectors may be controlled by an electromechanical, hydromechanical or piezoelectric actuator, for example, in response to prevailing engine load conditions.

In a dual stroke fuel injector, the two stroke positions are typically referred to as the short stroke and long stroke corresponding to low fuel flow and high fuel flow conditions, respectively. Injectors are designed to open and close with a pulse width modulation that supplies the correct amount of fuel to the engine. During relatively low engine load conditions, a dual injector executes short strokes, opening and closing the valve very quickly with quick injections of fuel to the engine. At higher engine load conditions, the dual injector executes a long stroke to allow more fuel to flow to the engine.

Dual stroke injectors require actuation for both the short stroke and long stroke stages of the injector. To accomplish this, many present day dual stroke injectors simply tend to add electromechanical actuator parts (e.g., a second solenoid) that make the injector more costly and bulky. A need therefore exists for an improved dual stroke injector that is cost efficient and not appreciably bigger than a single stroke injector.

### SUMMARY OF THE INVENTION

The present invention successfully addresses the above need by providing a dual stroke fuel injector that includes a shape memory alloy (SMA) actuator for executing the long stroke of the injector. More particularly, the SMA actuator is operable to retract one of a pair of armature stops within the injector. The armature controls movement of the valve needle in response to signals received by the engine. The first armature stop is fixed relative to the moving armature and needle. The second armature stop extends beyond the first armature stop to control the short stroke cycle of the injector. When the SMA actuator is energized, the second armature stop retracts relative to the first armature stop thereby allowing the valve needle to execute a long stroke.

### BRIEF DESCRIPTION OF THE DRAWINGS

The present invention will now be described, by way of example, with reference to the accompanying drawings, in which:

FIG. 1 is a longitudinal cross-section of an embodiment of the inventive fuel injector shown in the closed position;

FIG. 2 is the view of FIG. 1 with the injector shown in the short stroke position; and

FIG. 3 is the view of FIG. 1 with the injector shown in the long stroke position.

### DESCRIPTION OF THE PREFERRED EMBODIMENTS

Referring to the drawing figures, an embodiment of the inventive dual stroke fuel injector is shown generally by the reference numeral 10. Fuel injector 10 includes a body 12 having a fuel inlet 14 and fuel outlet 16. The fuel inlet 14 is adapted to be connected to a fuel line (not shown) for supply of fuel to the fuel injector 10. Fuel outlet 16 is adapted to direct fuel from the injector into a combustion chamber or intake manifold of an engine (not shown). Fuel injector 10 may be made for gasoline, diesel, or any other engine which could receive the benefits of a dual stroke injector.

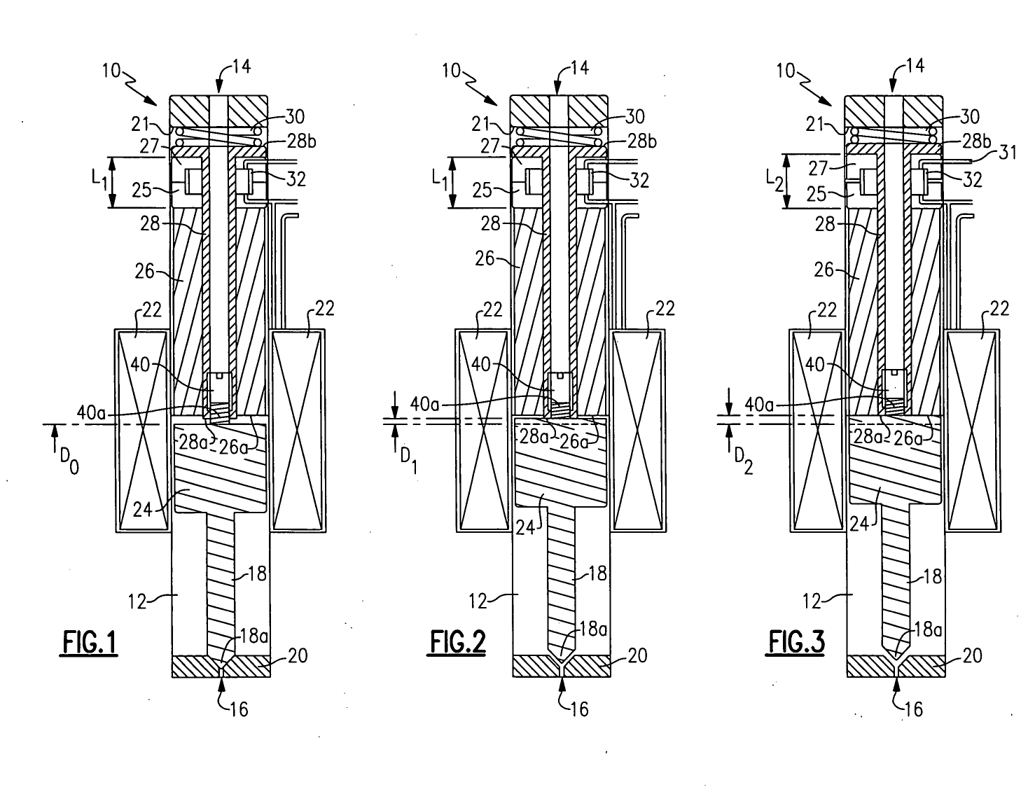

A fuel injector valve needle 18 is disposed within body 12 and includes a tip 18a that is cooperatively formed with valve seat 20 such that when valve needle 18 is in the closed position, valve tip 18a abuts valve seat 20 to prevent fuel from exiting fuel outlet 16 (see FIG. 1). When the engine is running, the fuel injectors open and close according to the designed pulse width modulation to deliver the correct amount of fuel to the engine.

As described above, fuel injector 10 is designed as a dual stroke injector.

As such, valve needle 18 may move from the fully closed position seen in FIG. 1 to either a short stroke position as seen in FIG. 2 or a long stroke position as seen in FIG. 3 according to the received engine load signal. It is understood that injector 10, through appropriate electrical connections, is operable to respond to engine load signals with the appropriate needle movement. Such connections are well known to those skilled in the art and will not be further elaborated upon herein.

In the preferred embodiment, needle movement is effected via a solenoid comprising a coil 22 surrounding injector body 12 and an armature 24 within body 12 and to which needle 18 is attached. Upon fuel injector 10 receiving a signal to open the valve needle from the closed position seen in FIG. 1, coil 22 is energized causing movement of armature 24 in a direction away from the fuel outlet 16, thereby lifting needle tip 18a from valve seat 20 to allow fuel to flow through outlet 16.

First and second armature stops 26 and 28, respectively, are provided within injector body 12 and act to limit the linear travel of needle 18 in the direction away from the fuel outlet 16. In the preferred embodiment, first armature stop 26 is fixed and second armature stop 28 is movable with respect to the first armature stop. Second armature stop is movable between the extended position seen in FIG. 2 and the retracted position seen in FIG. 3. When in the extended position, the end wall 28a thereof extends beyond the end wall 26a of the first armature stop 26.

In the preferred embodiment shown, armature stops 26 and 28 are arranged in coaxial relationship with second armature stop 28 positioned for reciprocating movement within first armature stop 26. It is understood, however, that the armature stops can be of any suitable shape and positional relationship depending on the particular injector design employed. Also, the movement of the movable armature stop may be along the longitudinal axis of the injector as shown, or may be adapted to move in a different direction such as radially, for example. It is furthermore noted that either or both armature stops may be made movable so long as they cooperatively operate to control movement of the armature between a short stroke and long stroke in accordance with the engine load signal received by the injector.

When second armature stop 28 is in this extended position, it forms a stop against which armature 24 abuts when traveling in a direction away from the fuel outlet. This movement is considered the short stroke of the injector and the linear distance traveled by armature 24 is indicated by D₁ in FIG. 2.

When armature stop 28 is in the retracted position seen in FIG. 3, end wall 28a lies in a plane that is at least flush or recessed with respect to end wall 26a of first armature stop 26. As such, end wall 26a acts as the stop against which armature 24 abuts when traveling in a direction away from the fuel outlet. In this instance, end wall 28a does not influence the stroke of the injector. This movement is considered the long stroke of the injector and the linear distance traveled by armature 24 is indicated by D₂ in FIG. 3 where D₁<D₂.

Movement of second armature stop 28, and thus the long stroke of the injector, is controlled by a shape memory alloy (SMA) component 32 via circuitry 31. In the preferred embodiment, the SMA component 32 is positioned between a fixed block 25 and a movable block 27. A helical spring 30 is located between end wall 28b and a spring stop 21 adjacent fuel inlet 14 although other spring shapes and positions within the injector are of course possible.

In the unactivated state, SMA component 32 has a first length L₁ that is not long enough to bear against and move movable block 27. As such, spring 30 is extended to bias second armature stop 28 in the extended (short stroke) position of FIG. 2. When activated via circuitry 31, SMA component 32 expands and lengthens to a length L₂ which bears against and moves movable block 27 upward to move end wall 28b and compress spring 30 (FIG. 3). As such, the bias against second armature stop 28 by spring 30 is relieved.

In this regard, it is seen that a core screw 40 and spring 40a extend from second armature stop 28 beyond end wall 28a to abut and bias armature 24 and needle 18 toward the closed position. Upon activation of coil 22, armature 24 moves against the bias of spring 40a to execute either a short stroke (second armature stop 28 extended) or a long stroke (second armature stop 28 retracted) in accordance with the received engine load signal. Once SMA component 32 is deactivated, the bias of spring 30 assists in returning SMA component 32 to its smaller length L₁ state seen in FIGS. 1 and 2. This causes second armature stop 28 to extend for a short stroke of the injector or close altogether depending on the engine load signal.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A dual stroke fuel injector having a valve movable from a closed position to short stroke and long stroke positions in response to received engine load signals, said injector including a shape memory alloy component for controlling which of the short and long stroke position is executed.

2. The fuel injector of claim 1 wherein activation of said shape memory alloy causes said valve to execute said long stroke.

3. The fuel injector of claim 1 wherein said shape memory alloy is a component having a length L₁ in the deactivated state and a length L₂ in the activated state where L₁ is less than L₂.

4. The fuel injector of claim 1 and further comprising an actuator for controlling movement of said valve.

5. The fuel injector of claim 4 and further comprising first and second armature stops for limiting the linear distance of travel of said valve to a short stroke or a long stroke position, respectively.

6. The fuel injector of claim 5 wherein said first armature stop is fixed and second armature stop is movable between extended and retracted positions with respect to said first armature stop, said valve executing a short stroke when said second armature stop is in said extended position, said valve executing said long stroke when said second armature stop is in said retracted position.

7. The injector of claim 6 wherein said second armature stop is positioned in coaxial relationship within said first armature stop.

8. The injector according to claim 6 wherein activation of said shape memory alloy causes said second armature to move to the retracted position and said valve to execute said long stroke.

9. The fuel injector of claim 8 wherein said shape memory alloy is a component having a length L₁ in the deactivated state and a length L₂ in the activated state where L₁ is less than L₂.

10. The fuel injector of claim 9 and further comprising a spring biasing said injector in the short stroke position, said shape memory alloy component moving against said bias when activated.

11. The fuel injector of claim 10 and further comprising first and second armature stops for limiting the linear distance of travel of said valve to a short stroke or a long stroke position, respectively.

12. The fuel injector of claim 11 wherein said injector includes a fuel inlet and fuel outlet and wherein said spring is positioned between said fuel inlet and said second armature stop.
